(19) United States
(12) Patent Application Publication
(10) Pub. No.: US 2025/0167502 A1
(43) Pub. Date: May 22, 2025

(54) METHOD FOR MANUFACTURING CONDUCTOR PLATE, CONDUCTOR PLATE, AND CONDUCTOR PLATE ASSEMBLY

(71) Applicant: HITACHI ASTEMO, LTD., Hitachinaka-shi, Ibaraki (JP)

(72) Inventor: Katsuhide OHASHI, Hitachinaka-shi, Ibaraki (JP)

(73) Assignee: HITACHI ASTEMO, LTD., Hitachinaka-shi, Ibaraki (JP)

(21) Appl. No.: 18/728,928

(22) PCT Filed: Jan. 19, 2022
(86) PCT No.: PCT/JP2022/001818

§ 371 Date: Jul. 15, 2024

(51) Int. Cl. H01R 43/16; H01R 4/58

(52) U.S. Cl. CPC H01R 43/16; H01R 4/58

(57) ABSTRACT

A method for manufacturing a conductor plate includes: a press process of forming a predetermined closed region by press molding and separating a predetermined bent region from the periphery of the closed region while leaving only a connection portion that is a part of the bent region; and a bending process of bending the bent region at the connection portion to laminate the bent region with the laminated region that is another region in the closed region, and developing a part of the bent region to the outside of the closed region.

### TECHNICAL FIELD

The present invention relates to a method for manufacturing a conductor plate, the conductor plate, and a conductor plate assembly.

### BACKGROUND ART

The conductor plate serving as a flow path of electric energy has various shapes depending on application. PTL 1 discloses an irreversible circuit element including a case, an electric component, and a magnetic component, in which the case accommodates the electric component and the magnetic component to configure a yoke, the magnetic component includes a magnetic rotor, the magnetic rotor includes a plurality of center conductors and a soft magnetic base, the plurality of center conductors are configured by a conductor plate and include a ground portion, an intermediate portion, and a terminal portion, the ground portion is configured by one conductor plate common to the plurality of center conductors, the intermediate portion is derived from the ground portion and includes a plurality of upright portions and a plurality of parallel portions, the plurality of upright portions are disposed upright with respect to the ground portion, the plurality of parallel portions are continuous with the plurality of upright portions and are disposed parallel to the ground portion, the plurality of parallel portions intersect each other at a predetermined angle and are insulated from each other, the plurality of upright portions include two upright portions in which inner surfaces are disposed opposite and parallel to each other, the soft magnetic base is a substantially quadrangular flat plate including two side surfaces parallel to each other, a thickness dimension of the flat plate is set to be the same as or smaller than a height dimension inside the plurality of upright portions, a dimension between the two side surfaces parallel to each other is set to be the same as or smaller than a dimension between the inner surfaces of the upright portions disposed opposite and parallel to each other, the soft magnetic base is inserted into the center conductor, and the plurality of upright portions and the plurality of parallel portions are bent using a bending jig, and the bending jig is a reference piece imitating a shape of the soft magnetic base.

### CITATION LIST

### Patent Literature

PTL 1: JP 2004-304211 A

### SUMMARY OF INVENTION

### Technical Problem

In the invention described in PTL 1, there is room for improvement in the method for manufacturing the conductor plate.

### Solution to Problem

A first aspect of the present invention is a method for manufacturing a conductor plate including: a press process of forming a predetermined closed region by press molding, and separating a predetermined bent region from a periphery while leaving only a connection portion that is a part of the bent region in the closed region; and a bending process of bending the bent region at the connection portion to laminate the bent region with a laminated region that is another region in the closed region, and developing the part of the bent region outside the closed region.

A second aspect of the present invention is a conductor plate including: a flat plate-shaped predetermined closed region; and an external terminal protruding from the closed region, in which the closed region includes a terminal formation hole that is a hole, an internal terminal connected to the external terminal is formed at a connection portion that is an end of the terminal formation hole, and a volume of each of the external terminal and the internal terminal is substantially identical to a volume of the terminal formation hole.

A third aspect of the present invention is a conductor plate assembly including: a first conductor plate having a flat plate shape; a second conductor plate that has a flat plate shape and is disposed so as to be laminated with the first conductor plate; and an insulating member disposed between the first conductor plate and the second conductor plate, in which each of the first conductor plate and the second conductor plate includes: a flat plate-shaped predetermined closed region; and an external terminal protruding from the closed region, the closed region includes a terminal formation hole which is a hole, an internal terminal connected to the external terminal is formed at a connection portion that is an end of the terminal formation hole, a volume of each of the external terminal and the internal terminal is substantially identical to a volume of the terminal formation hole, the internal terminal of the first conductor plate is formed on a side opposite to the second conductor plate, and the internal terminal of the second conductor plate is formed on a side opposite to the first conductor plate.

### Advantageous Effects of Invention

According to the present invention, the yield of the conductor plate can be improved.

### BRIEF DESCRIPTION OF DRAWINGS

FIG. 1 is a perspective view illustrating a conductor plate 1 according to a first embodiment.

FIG. 2 is a view illustrating an outline of a method for manufacturing the conductor plate 1.

FIG. 3 is a view illustrating details of a press plate 92.

FIG. 4 is a view illustrating details of an intermediate state 93 and the conductor plate 1.

FIG. 5 is a view illustrating an advantage of the method for manufacturing the conductor plate 1 of the first embodiment.

FIG. 6 is a perspective view illustrating a conductor plate 1A according to a second embodiment.

FIG. 7 is a view illustrating a manufacturing process of the conductor plate 1A of the second embodiment.

FIG. 8 is a schematic view illustrating a conductor plate assembly A.

FIG. 9 is an enlarged view illustrating a portion of a bent region 243 in a first conductor plate 1P and a second conductor plate 10.

### DESCRIPTION OF EMBODIMENTS

### First Embodiment

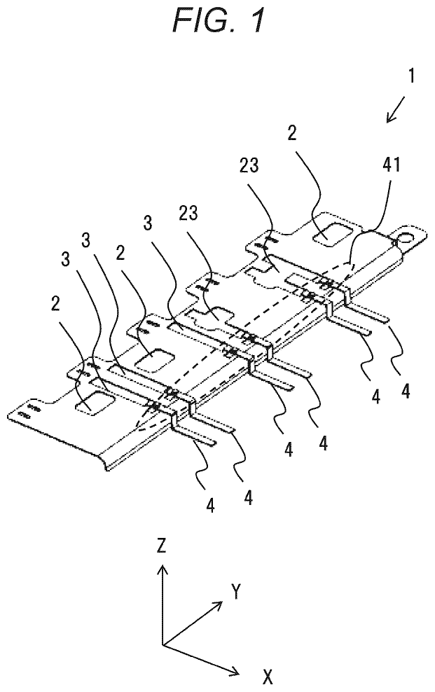

A method for manufacturing a conductor plate and the conductor plate according to a first embodiment will be described below with reference to FIGS. 1 to 5.

FIG. 1 is a perspective view illustrating a conductor plate 1 of the first embodiment. In the first embodiment, mutually orthogonal XYZ-axes are defined in order to clearly indicate a correlation between drawings. In addition, rotation in a clockwise direction toward a positive direction of each axis is defined as a positive direction, in other words, rotation in a normal direction. The conductor plate 1 has a substantially flat plate shape extending in an XY-plane. The conductor plate 1 has a plurality of through-holes 2, a plurality of terminal formation holes 3, a plurality of composite holes 23, and a plurality of terminals 4. Both the through-hole 2 and the terminal formation hole 3 are holes penetrating the conductor plate 1.

Each of the terminal formation hole 3 and the terminal 4 has a rectangular shape and has a longitudinal direction in an X-axis direction. A number of the terminal formation holes 3 and a number of the terminals 4 are the same, and the terminal formation hole 3 and the terminal 4 are adjacent to each other in the X-axis direction. The terminal formation hole 3 is made as a pair with the terminal 4, whereas the through-hole 2 is not particularly limited to a positional relationship with another configuration.

The composite hole 23 is a hole in which the through-hole 2 and the terminal formation hole 3 are connected to each other. The composite hole 23 is merely made because the through-hole 2 and the terminal formation hole 3 are disposed at positions relatively close to each other for design convenience, and does not have a special configuration and function beyond the through-hole 2 and the terminal formation hole 3. Accordingly, the composite hole 23 will not be particularly described below.

Each terminal 4 includes a fixing portion 41 in the vicinity of a minus-side end of an X-axis. However, in FIG. 1, for convenience of drawing, a plurality of fixing portions 41 are collectively denoted by a reference numeral surrounded by a circular broken line. Details of the fixing portion 41 will be described later.

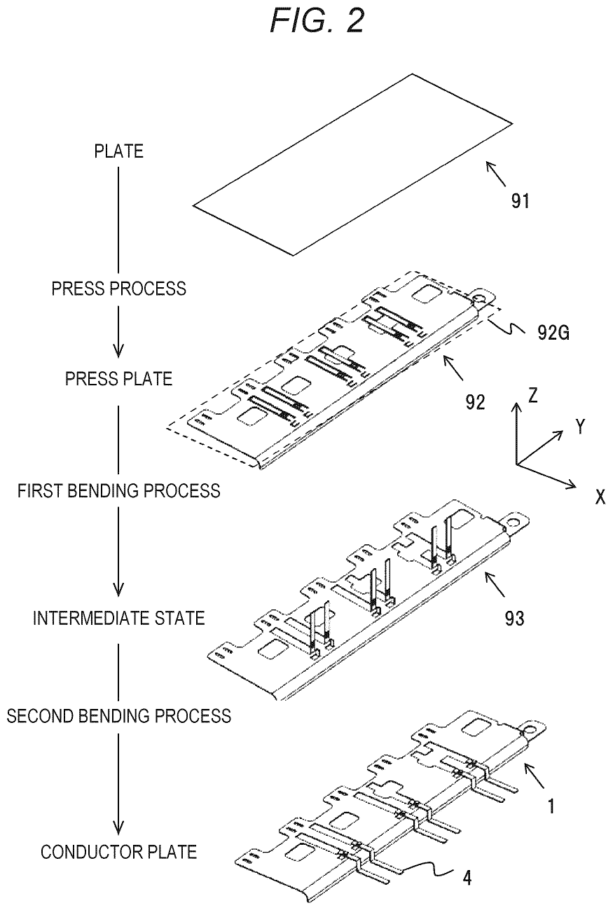

FIG. 2 is a view illustrating an outline of a method for manufacturing the conductor plate 1. A viewpoint in FIG. 2 is the same as that in FIG. 1. First, a plate 91, which is a plate-like material as a conductor, undergoes a press process to become a press plate 92. Then, an intermediate state 93 is established by a first bending process, and the conductor plate 1 in FIG. 1 is completed through a second bending process. Hereinafter, the first bending process and the second bending process are collectively referred to as a “bending process”. Hereinafter, an outer periphery of the press plate 92, particularly an outer edge of the press plate 92 projected on the XY-plane is referred to as an outer peripheral edge 92G, and an inner side of the outer peripheral edge 92G is referred to as a closed region.

The outer peripheral edge 92G, the through-hole 2, and a member that becomes the terminal 4 and the fixing portion 41 in a later process are formed in the press process. Strictly, in the press process, the terminal 4 and the fixing portion 41 can be bent in the subsequent bending process by punching a periphery of the member that becomes the terminal 4 and the fixing portion 41. A space generated in the plate 91 by bending the terminal 4 is the terminal formation hole 3. That is, the terminal formation hole 3 and the terminal 4 have substantially the same shape. In the first embodiment, the terminal formation hole 3 and the terminal 4 similarly have the rectangular shape, and two of the four sides of each of the terminal formation hole 3 and the terminal 4 are parallel to the X-axis and the other two sides are parallel to a Y-axis.

In a first bending process, the press plate 92 is set to the intermediate state 93 by rotating each terminal 4 by plus 90 degrees about the Y-axis along an XZ-plane. In a second bending process, each terminal 4 is further rotated by plus 90 degrees about the Y-axis along the XZ-plane. That is, when the first bending process and the second bending process are combined, each terminal 4 is rotated by plus 180 degrees about the Y-axis along the XZ-plane.

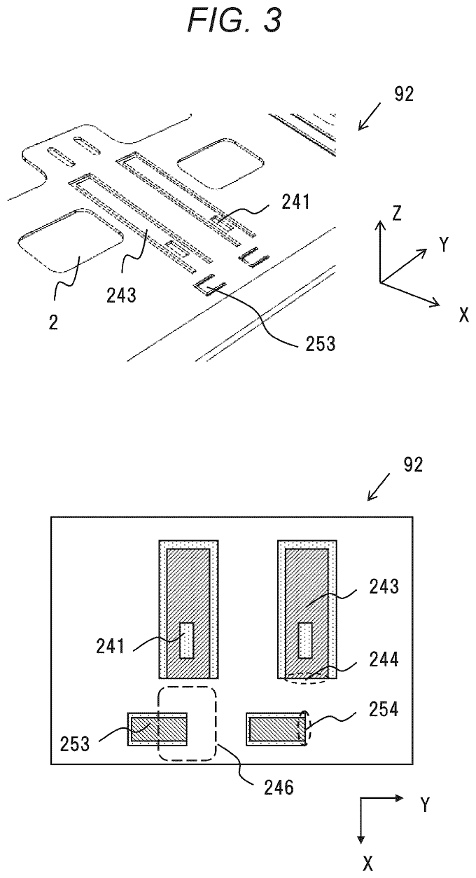

FIG. 3 is a view illustrating details of the press plate 92. An upper part of FIG. 3 is a perspective view from the same viewpoint as FIG. 2, and a lower part of FIG. 3 is a plan view illustrating the XY-plane. However, in the XY-plan view, the shape of the press plate 92 is simplified for convenience of drawing.

A bent region 243 that becomes the terminal 4 later and a protrusion formation region 253 configuring a part of the fixing portion 41 later are formed in the press plate 92. The bent region 243 and the protrusion formation region 253 are rectangular regions. In the XY-plan view illustrated in the lower part of FIG. 3, hatching of dots indicates a region punched out in the press process, hatching of right oblique lines indicates the bent region 243, and hatching of left lanes indicates the protrusion formation region 253. For convenience of drawing, illustration is omitted in the upper part of FIG. 3 and only illustrated in the lower part of FIG. 3, but a side of the bent region 243 on the positive side in an X-direction is referred to as a connection portion 244, and an end of the protrusion formation region 253 on the positive side in a Y-direction is referred to as a protrusion connection portion 254. A fitting hole 241, which is a hole penetrating the vicinity of the connection portion 244, is made in the bent region 243.

That is, the bent region 243 is separated from the periphery except for the connection portion 244 in the press process. In addition, the protrusion formation region 253 is separated from the periphery except for the protrusion connection portion 254 in the press process. In the following description, a region having a width of the bent region 243 and on the plus side of the X-axis with respect to the connection portion 244 in the press plate 92 is referred to as a laminated region 246. Strictly, the region of the protrusion formation region 253 is not included in the laminated region 246.

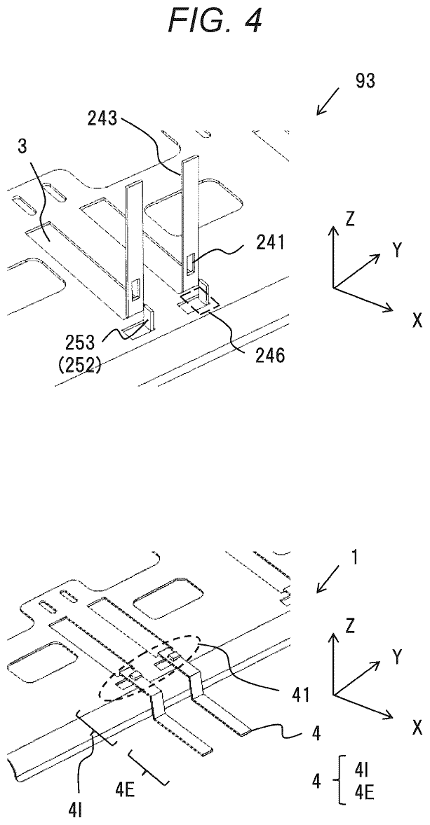

FIG. 4 is a view illustrating details of the intermediate state 93 and the conductor plate 1. The intermediate state 93 is obtained by performing the first bending process on the press plate 92 in FIG. 3. In the first bending process, the bent region 243 is rotated by plus 90 degrees about the Y-axis about the connection portion 244 as a rotation center. In the first bending process, the protrusion formation region 253 is rotated about the protrusion connection portion 254 by minus 90 degrees about the X-axis. The conductor plate 1 is obtained by performing the second bending process on the intermediate state 93 thus obtained. Hereinafter, the protrusion formation region 253 subjected to the bending processing is also referred to as a protrusion 252.

In the second bending process, first, the bent region 243 is further rotated by plus 90 degrees about the Y-axis about the connection portion 244 as the rotation center. Consequently, the protrusion 252 is inserted into the fitting hole 241 of the bent region 243, and the bent region 243 is laminated on the laminated region 246. A region where the member does not exist is generated in the intermediate state 93 when the bent region 243 moves, and this becomes the terminal formation hole 3 in the conductor plate 1. Thereafter, the protrusion 252 is further rotated by minus 90 degrees about the X-axis, the positions of the fitting hole 241 and the protrusion 252 are fixed, and the fixing portion 41 is formed. However, in the second bending process, the protrusion 252 may be rotated toward the plus side by 90 degrees.

Although included in the bending process in the first embodiment, the process of rotating the protrusion formation region 253 in the first bending process and the second bending process is a process of forming the fixing portion 41, and thus can also be referred to as a “fixing process”. In addition, it can also be said that when the terminal 4 is divided into two for convenience, an internal terminal 4I existing inside the outer peripheral edge 92G and an external terminal 4E existing outside the outer peripheral edge 92G are connected to each other. Furthermore, it can also be said that when the connection portion 244 is considered as a starting point, the internal terminal 4I connected to the external terminal 4E is formed in the connection portion 244 that is the end of the terminal formation hole 3.

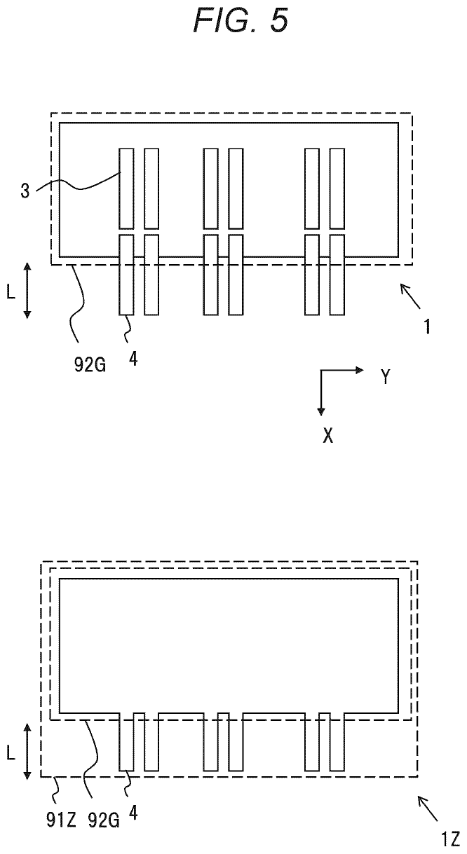

FIG. 5 is a view illustrating advantages of the above-described method for manufacturing the conductor plate 1. Specifically, the upper part of FIG. 5 illustrates the size of the plate 91 in the case of using the manufacturing method according to the first embodiment, and the lower part of FIG. 4 illustrates the size of a plate 91Z of a comparative example in the case of using the method for manufacturing a conductor plate 1Z of the comparative example. However, the outside dimension of the conductor plate 1Z of the comparative example is the same as that of the conductor plate 1.

In the manufacturing method of the first embodiment, the terminal 4 is formed by folding back the portion of the terminal formation hole 3 existing on the inner peripheral side of the outer peripheral edge 92G at a connection side. For this reason, the plate 91 used for manufacturing the conductor plate 1 may have the size of the outer peripheral edge 92G. A length of the terminal 4 protruding from the outer peripheral edge 92G is referred to as a length L.

The conductor plate 1Z of the comparative example is manufactured from the plate 91Z of the comparative example by one-time press working. In this case, the plate 91Z of the comparative example has a larger dimension than the outer peripheral edge 92G by the length L. Consequently, in the manufacturing method according to the first embodiment, an area of the plate 91 required for manufacturing the conductor plate 1 having the same shape may be small, so that a yield can be improved.

According to the first embodiment described above, the following operational effects can be obtained.

(1) The method for manufacturing the conductor plate 1 includes the press process and the bending process. In the press process, the predetermined closed region having the outer peripheral edge 92G is formed by press molding the plate 91 as a processing target, and the predetermined bent region 243 is separated from the periphery while leaving only the connection portion 244 that is a part of the bent region in the closed region. In the bending process, the bent region 243 is laminated with the laminated region 246 that is another region in the closed region by bending the bent region 243 at the connection portion 244, and a part of the bent region is developed outside the closed region. Consequently, the conductor plate 1 can be manufactured using the plate 91 having the small region, so that the yield of the conductor plate 1 can be improved.

(2) The method for manufacturing the conductor plate 1 includes the fixing process that is the process of rotating the protrusion formation region 253 in the first bending process and the second bending process. However, this fixing process can also be said to be the process of fixing the bent region 243 and the laminated region 246. Consequently, the shape of the conductor plate 1 can be held by fixing the bending of the bent region 243.

(3) The press process includes forming the fitting hole 241 that is the hole penetrating the bent region 243. Similarly, the press process includes separating the predetermined protrusion formation region 253 from the periphery while only the protrusion connection portion 254 that is a part of the protrusion formation region 253 is left. In the fixing process, the protrusion 252 is formed by bending the protrusion formation region 253 in the protrusion connection portion 254, and the bent region 243 and the laminated region 246 are fixed by further bending the protrusion 252 passed through the fitting hole 241. Consequently, the bent region 243 can be firmly fixed.

(4) The bent region 243 has the rectangular shape, and the connection portion 244 is the short side of the rectangular shape. Consequently, the wide region of the bent region 243 can be easily protruded to the outside of the outer peripheral edge 92G.

(5) The bent region 243 is the region having the longitudinal direction, and the longitudinal direction of the bent region 243 is the X-axis direction and is substantially the same before and after the bending process. Consequently, it is sufficient to rotate the bent region 243 by 180 degrees about the Y-axis in the bending process, so that the processing content is simple and a construction error is hardly generated.

(6) The conductor plate 1 has the flat plate shape, and includes the predetermined closed region surrounded by the outer peripheral edge 92G and the external terminal 4E protruding from the outer peripheral edge 92G. The closed region has the terminal formation hole 3 that is the hole. The internal terminal 4I connected to the external terminal 4E is formed in the connection portion 244 that is the end of the terminal formation hole 3. The total volume of the external terminal 4E and the internal terminal 4I is substantially the same as that of the terminal formation hole 3. Consequently, the external terminal 4E and the internal terminal 4I are formed using the member existing in the terminal formation hole 3, so that the conductor plate 1 can be formed using the small number of plates 91. In addition, the layers are stacked in the laminated region 246, so that the conduction region is enlarged and the calorific value can be reduced.

### (Modification 1)

The terminal 4 may not include the fixing portion 41, namely, the fitting hole 241 and the protrusion 252 at the root, and the fixing process may not be included in the manufacturing process of the conductor plate 1. In this case, because the conductor plate 1 does not include the fixing portion 41, constraint of the terminal 4 is weak, but the disadvantage that the fixing portion 41 is included can be reduced by appropriately selecting the material of the plate 91. According to the first modification, the conductor plate 1 can be manufactured with a small number of processes.

### (Modification 2)

The conductor plate 1 may not include the through-hole 2. Although the conductor plate 1 includes the plurality of terminal formation holes 3 and the plurality of terminals 4 in the first embodiment, the conductor plate 1 may include at least one terminal formation hole 3 and at least one terminal 4. Furthermore, the conductor plate 1 may not include the composite hole 23.

### (Modification 3)

The configuration of the fixing portion 41 is not limited to the configuration in the first embodiment described above. For example, the bent region 243 may be fixed to the laminated region 246 by bending the protrusion 252 and caulking the bent region 243 without using the fitting hole 241, or the bent region 243 may be fixed to the laminated region 246 by welding. Furthermore, the bent region 243 may be fixed to the laminated region 246 using another member such as a screw.

### (Modification 4)

A sealing process of sealing a part of the conductor plate 1, particularly a region excluding the terminal 4, with an insulating resin member may be further included after the bending process. Unintended electrical contact of the conductor plate 1 can be prevented.

### Second Embodiment

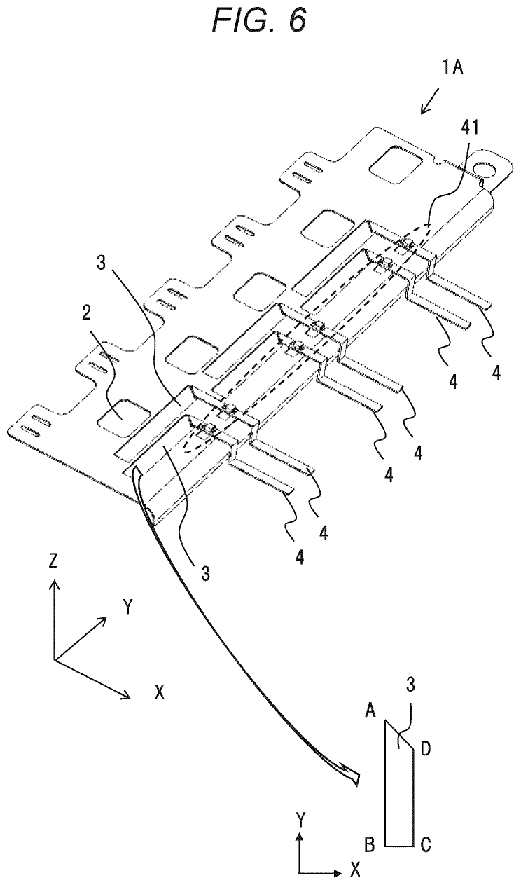

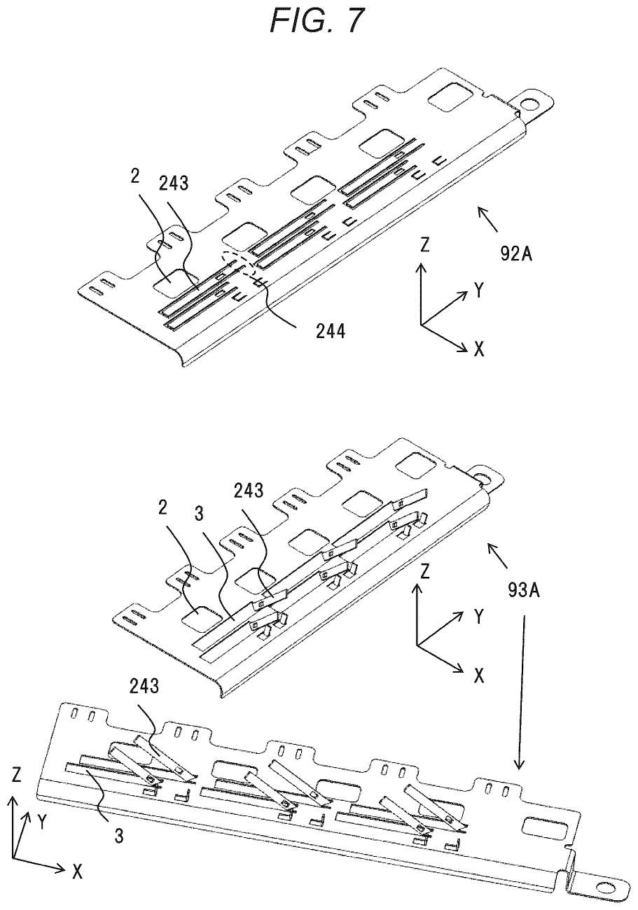

A method for manufacturing a conductor plate and the conductor plate according to a second embodiment will be described with reference to FIGS. 6 to 7. In the following description, the same components as those of the first embodiment are denoted by the same reference numerals, and differences will be mainly described. The points not specifically described are the same as those in the first embodiment. The second embodiment is different from the first embodiment mainly in the formation position and the bending direction of the terminal 4.

FIG. 6 is a perspective view illustrating a conductor plate 1A of the second embodiment. The second embodiment is similar to the first embodiment in that the terminal 4 has the longitudinal direction in the X-axis direction, but is different from the first embodiment in that the terminal formation hole 3 has the longitudinal direction in the Y-axis direction. In addition, the shapes of the terminal formation hole 3 and the terminal 4 are slightly different from those of the first embodiment.

A lower right of FIG. 6 is a schematic view illustrating a shape of the terminal formation hole 3. The terminal formation hole 3 of the second embodiment has a quadrangular shape having vertices A, B, C, D as illustrated in the lower right of FIG. 5. In this quadrangle, a side AB and a side CD are parallel to the Y-axis, and a side BC is parallel to the X-axis. However, a side DA that is a connection side is not parallel to any axis and has an angle of 45 degrees with respect to the X-axis and the Y-axis. That is, an angle BAD is 45 degrees and an angle ADC is 135 degrees. Consequently, although the terminal formation hole 3 has the longitudinal direction parallel to the Y-axis, the terminal formation hole 3 is bent in accordance with the angle of the connection side in the bending process, and thus the terminal 4 has the longitudinal direction parallel to the X-axis. In other words, the terminal 4 is rotated by plus 90 degrees about the Z-axis on the XY-plane in the bending process.

FIG. 7 is a view illustrating a process of manufacturing the conductor plate 1A in the second embodiment. Also in the second embodiment, similarly to the first embodiment, the conductor plate 1A is manufactured through the press process, the first bending process, and the second bending process. FIG. 7 illustrates a press plate 92A in the state where the press process is completed and an intermediate state 93A in the state where the first bending process is completed. However, two figures of the intermediate state 93A are illustrated while the viewpoint to help grasp the state is changed.

In the second embodiment, the bent region 243 has the longitudinal direction in the Y-axis direction. In the bending process, the bent region 243 is rotated about the connection portion 244 as the rotation center similarly to the first embodiment. However, in the second embodiment, when the rotation is completed, the bent region 243 is obliquely rotated such that the longitudinal direction of the bent region 243 becomes parallel to the X-axis.

According to the second embodiment described above, the following operational effects can be obtained.

(7) The closed region inside the outer peripheral edge 92G extends in the X-axis direction and the Y-axis direction orthogonal to the X-axis. As illustrated in the upper part of FIG. 7, the bent region 243 formed in the press process has the longitudinal direction in the Y-axis direction. As illustrated in the lower part of FIG. 7, in the bending process, the bent region 243 is bent so as to have the longitudinal direction in the X-axis direction. Consequently, a degree of freedom of the arrangement position of the terminal formation hole 3 is improved, and various designs can be made.

### (Modification of Second Embodiment)

In the second embodiment, the longitudinal direction of the bent region 243 is different by 90 degrees in the XY-plane before and after the bending process. However, this angle is not limited to 90 degrees, but any angle can be adopted.

### Third Embodiment

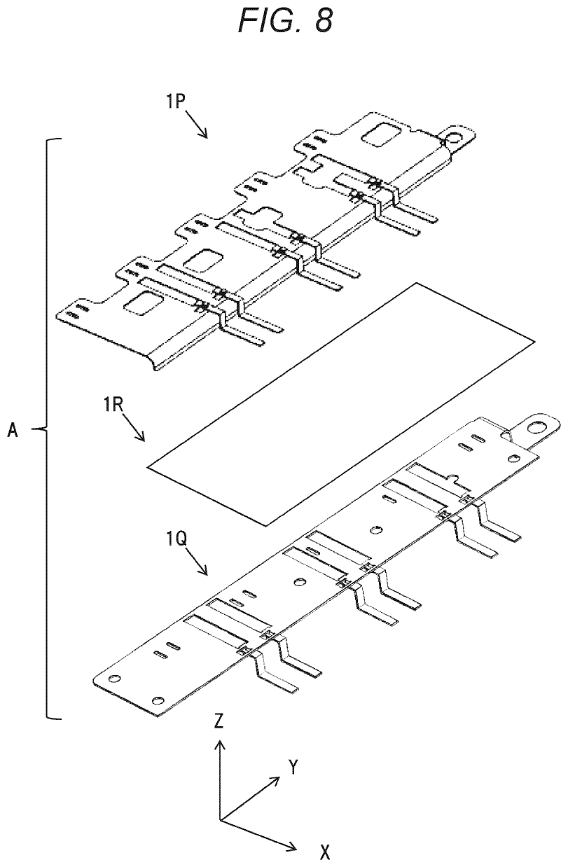

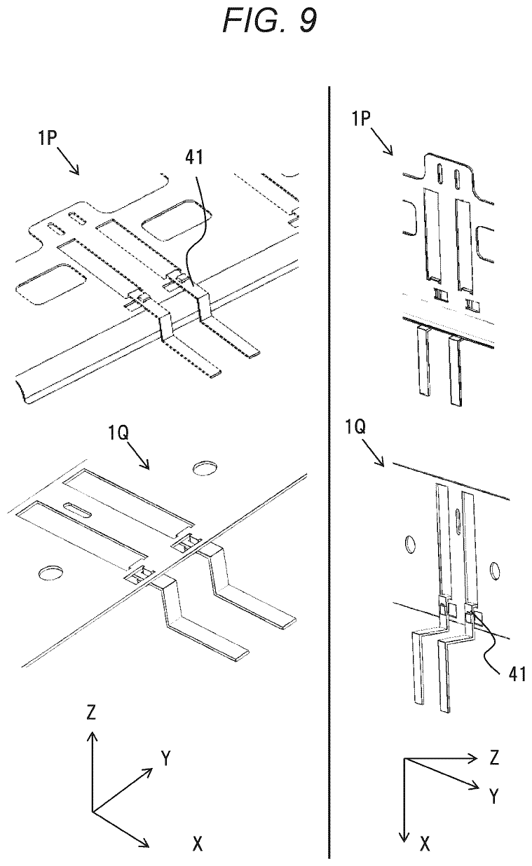

A conductor plate assembly according to a third embodiment will be described with reference to FIGS. 8 to 9. In the following description, the same components as those of the first embodiment are denoted by the same reference numerals, and differences will be mainly described. The points not specifically described are the same as those in the first embodiment. The third embodiment is different from the first embodiment mainly in that two conductor plates are combined.

FIG. 8 is a schematic view illustrating a conductor plate assembly A. The conductor plate assembly A includes a flat plate-shaped first conductor plate 1P, a flat plate-shaped second conductor plate 10, and an insulating member R disposed between the first conductor plate 1P and the second conductor plate 10. In FIG. 8, the insulating member R is described as a sheet-like member, but it is sufficient that the first conductor plate 1P and the second conductor plate 10 may be insulated from each other, and the insulating member R may be formed integrally with the first conductor plate 1P or the second conductor plate 10. For example, after the bending process including the fixing process is completed, parts of the first conductor plate 1P and the second conductor plate 10, for example, all the regions except for the terminal 4 may be sealed with an insulating resin member. The first conductor plate 1P is the same as the conductor plate 1 of the first embodiment. The difference between the first conductor plate 1P and the second conductor plate 10 is the bending direction of the bent region 243 in the bending process. The bent region 243 is bent in the plus Z-direction in the first conductor plate 1P, and the bent region 243 is bent in the minus Z-direction in the second conductor plate 10.

FIG. 9 is an enlarged view illustrating a portion of the bent region 243 in the first conductor plate 1P and the second conductor plate 10. In the four views of FIG. 9, the upper two are the first conductor plate 1P, and the lower two are the second conductor plate 10. Among the four views of FIG. 9, the left two have the same viewpoints as those in FIG. 8, and the right two have viewpoints greatly different from those in FIG. 8, and illustrate the surfaces of the first conductor plate 1P and the second conductor plate 10 on the negative side of the Z-axis. As illustrated in FIG. 9, the internal terminal 4I of the first conductor plate 1P is formed on the Z-axis plus side, namely, the side opposite to the second conductor plate 10, and the internal terminal 4I of the second conductor plate 10 is formed on the Z-axis minus side, namely, the side opposite to the first conductor plate 1P. Consequently, the interval between the terminals 4 of the first conductor plate 1P and the second conductor plate 10 can be secured to easily secure an insulation distance.

According to the third embodiment described above, the following operational effects can be obtained.

(8) The conductor plate assembly A includes the first conductor plate 1P having the flat plate shape, the second conductor plate 10 having the flat plate shape disposed so as to be laminated with the first conductor plate 1P, and the insulating member R disposed between the first conductor plate 1P and the second conductor plate 10. The internal terminal 4I of the first conductor plate 1P is formed on the side opposite to the second conductor plate 10, and the internal terminal 4I of the second conductor plate 10 is formed on the side opposite to the first conductor plate 1P. Consequently, the interval between the terminals 4 of the first conductor plate 1P and the second conductor plate 10 can be secured to easily secure an insulation distance.

The above-described embodiments and modifications may be combined. Although various embodiments and modifications have been described above, the present invention is not limited to these contents. Other aspects conceivable within the scope of the technical idea of the present invention are also included within the scope of the present invention.

### REFERENCE SIGNS LIST

1, 1A conductor plate
1P first conductor plate
1Q second conductor plate
3 terminal formation hole
4 terminal
4E external terminal
4I internal terminal
41 fixing portion
91 plate
92, 92A press plate
92G outer peripheral edge
93 intermediate state
93A intermediate state
241 fitting hole
243 bent region
244 connection portion
246 laminated region
252 protrusion
253 protrusion formation region
254 protrusion connection portion
A conductor plate assembly
R insulating member

1. A method for manufacturing a conductor plate comprising:
a press process of forming a predetermined closed region by press molding, and separating a predetermined bent region from a periphery while leaving only a connection portion that is a part of the bent region in the closed region; and
a bending process of bending the bent region at the connection portion to laminate the bent region with a laminated region that is another region in the closed region, and developing the part of the bent region outside the closed region.

2. The method for manufacturing the conductor plate according to claim 1, further comprising a fixing process of fixing the bent region and the laminated region.

3. The method for manufacturing the conductor plate according to claim 2, wherein
in the press process, a fitting hole that is a hole penetrating through the bent region is further made,
in the press process, a predetermined protrusion formation region is further separated from a periphery while only a protrusion connection portion that is a part of the protrusion formation region is left, and
in the fixing process, a protrusion is formed by bending the protrusion formation region in the protrusion connection portion, and the bent region and the laminated region are fixed by further bending the protrusion passed through the fitting hole.

4. The method for manufacturing a conductor plate according to claim 1, further comprising a sealing process of sealing a part of the conductor plate with an insulating resin member after the bending process.

5. The method for manufacturing the conductor plate according to claim 1, wherein the bent region is a rectangle, and the connection portion is a short side of the rectangle.

6. The method for manufacturing the conductor plate according to claim 1, wherein
the bent region is a region having a longitudinal direction, and
the longitudinal direction of the bent region is substantially identical before and after the bending process.

7. The method for manufacturing a conductor plate according to claim 1, wherein
the closed region extends in an X-axis direction and a Y-axis direction orthogonal to the X-axis,
the bent region formed in the press process has a longitudinal direction in the Y-axis direction, and
in the bending process, the bent region is bent so as to have a longitudinal direction in the X-axis direction.

8. A conductor plate comprising:
a flat plate-shaped predetermined closed region; and
an external terminal protruding from the closed region,
wherein the closed region includes a terminal formation hole that is a hole,
an internal terminal connected to the external terminal is formed at a connection portion that is an end of the terminal formation hole, and
a volume of each of the external terminal and the internal terminal is substantially identical to a volume of the terminal formation hole.

9. A conductor plate assembly comprising:
a first conductor plate having a flat plate shape;
a second conductor plate that has a flat plate shape and is disposed so as to be laminated with the first conductor plate; and
an insulating member disposed between the first conductor plate and the second conductor plate,
wherein each of the first conductor plate and the second conductor plate includes:
a flat plate-shaped predetermined closed region; and
an external terminal protruding from the closed region,
the closed region includes a terminal formation hole which is a hole,
an internal terminal connected to the external terminal is formed at a connection portion that is an end of the terminal formation hole,
a volume of each of the external terminal and the internal terminal is substantially identical to a volume of the terminal formation hole,
the internal terminal of the first conductor plate is formed on a side opposite to the second conductor plate, and
the internal terminal of the second conductor plate is formed on a side opposite to the first conductor plate.
